(19) United States
(12) Patent Application Publication
(10) Pub. No.: US 2026/0129700 A1
(43) Pub. Date: May 7, 2026

(54) MULTI-LINK OPERATION ASSISTED BEAM REFINEMENT PROTOCOL FOR MMWAVE LINK

(71) Applicant: NXP USA, Inc., AUSTIN, TX (US)

(72) Inventors: Xiayu Zheng, San Jose, CA (US); Liwen Chu, San Ramon, CA (US); Rui Cao, Sunnyvale, CA (US); Hongyuan Zhang, Fremont, CA (US)

(21) Appl. No.: 19/365,070

(22) Filed: Oct. 21, 2025

Related U.S. Application Data
(60) Provisional application No. 63/714,936, filed on Nov. 1, 2024.

(51) Int. Cl. H04W 76/15; H04W 72/0453

(52) U.S. Cl. CPC H04W 76/15; H04W 72/0453

(57) ABSTRACT

A wireless communication method, system, and apparatus are provided to perform analog beamforming training with beam tracking for slow channel changes or beam refinement by generating beam refinement training control information regarding a mmWave link between a beamforming training initiator and responder, where the initiator transmits a training PPDU sequence to the responder through the mmWave link under control of the beam refinement training control information, and then receives a signal quality feedback message with a first signal quality measure from the responder through the mmWave link or non-mmWave link in response to the responder detecting and measuring the training PPDU sequence under control of the beam refinement training control information, where the initiator uses the signal quality measure to perform beam tracking and refinement to the established mmWave link by determining the transmit AWV or beam ranking for analog beamforming training of the initiator.

### CROSS-REFERENCE TO RELATED APPLICATION AND PRIORITY CLAIM

This application claims the benefit of U.S. Provisional Patent Application No. 63/714,936 entitled “MLO Assisted Beam Refinement Protocol for mmWave Link” filed Nov. 1, 2024, which is incorporated by reference in its entirety as if fully set forth herein.

### BACKGROUND

### Field

The present disclosure is directed in general to communication networks. In one aspect, the present disclosure relates generally to wireless local area network (WLAN) implementing the Institute of Electrical and Electronics Engineers (IEEE) 802.11 standard and any other standards and/or networks that can provide wireless transfer of data over a millimeter wave link.

### Description of the Related Art

An ever-increasing number of relatively inexpensive, low power wireless data communication services, networks and devices have been made available over the past number of years, promising near wire speed transmission and reliability. Enabling technology advances in the area of wireless communications, various wireless technology standards (including for example, the IEEE Standards 802.11a/b/g, 802.11n, 802.11ad, 802.11ac, 802.11ax, 802.11ay, and 802.11be and their updates and amendments, as well as the IEEE Standard 802.11bq now in the process of being developed) have been introduced that are known to persons skilled in the art and are collectively incorporated by reference as if set forth fully herein fully. For example, the 802.11be amendment to the IEEE 802.11 standard (“Wi-Fi 7”) added support for Multi-Link Operation (MLO). This feature increases capacity by simultaneously sending and receiving data across different frequency bands and channels (e.g., 2.4 GHz, 5 GHz, and 6 GHz). With MLO, for example, an access point multi-link device (AP MLD) simultaneously establishes multiple links with a non-AP MLD client over more than one frequency band in order to increases throughput, reduce latency, and improve reliability. Multi-Link Operation also supports various operating modes.

Another advance with wireless communications was proposed in the 802.11ad, 802.11ay, and 802.11aj standards which defined wireless communication standards in the 60 GHz or 45 GHz (China) mmWave band. In this area, the beamforming with a large number of antennas is identified as one of the most important mechanism in mmWave bands to compensate for the high pathloss for directional multi-gigabit communication (DMG, e.g., see P802.11-REVme/D4.0, August 2023). To balance the trade-off between cost and performance, the implementation of beamforming is composed of both analog beamforming and/or digital beamforming (or hybrid beamforming for MIMO case) for DMG beamforming. In the existing DMG approach for mmWave communication link signaling, there is an initial sector level sweep (SLS) phase to find the transmit and receive antenna weight vectors (AWV) for analog beamforming to enable the AP and STA to communicate, where the AP is the SLS initiator and the SLS is usually conducted periodically based on the beacon interval. In addition, there is a beam refinement protocol (BRP) phase to further train the device's receive and transmit antenna array(s) and improve its transmit (Tx) and receive (Rx) antenna configuration on top of SLS using an iterative procedure with BRP frame. When multiple Tx/Rx RF chains (each connecting to an antenna array) are enabled, the digital beamforming training could be further conducted once the analog beaming with BRP procedure is done and the analog AWVs are applied on both Tx/Rx RF chains. Under the existing DMG approach for mmWave communication link signaling, all the beamforming training packet exchanges are conducted in the mmWave band as a standalone mode. In addition, a special control PHY is required that is defined with 15 dB sensitivity margin over the lowest MCS to assist the training procedure, which also complicates the beamforming protocol design. As seen from the foregoing, there are performance vs. complexity vs. hardware cost trade-offs with the existing DMG approach for mmWave communication link signaling which are non-trivial to solve, and as a result, these standards with the DMG approach are not widely adopted in the market due to the complexity and high cost.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a simplified block diagram of a multi-link communications system in accordance with selected embodiments of the present disclosure.

FIG. 2 is a simplified block diagram of a wireless communications system in accordance with selected embodiments of the present disclosure.

FIG. 3 illustrates an example of a frame exchange sequence for an MLO-assisted BRP procedure for an initiator and responder which have TX/RX beam reciprocity and which exchange control frames on a non-mmWave link to set up an announcement frame exchange on the mmWave link for the initiator to transmit a BRP training PPDU sequence at the mmWave link and for the responder to provide feedback at the mmWave link in accordance with selected embodiments of the present disclosure.

FIG. 4 illustrates an example of a frame exchange sequence for an MLO-assisted BRP procedure for an initiator and responder which do not have TX/RX beam reciprocity and which exchange control frames on a non-mmWave link to set up an announcement frame exchange on the mmWave link for the initiator and responder to sequentially transmit respective BRP training PPDU sequences at the mmWave link, where the initiator and responder subsequently provide feedback at the mmWave link in accordance with selected embodiments of the present disclosure.

FIG. 5 illustrates an example of a frame exchange sequence for an MLO-assisted BRP procedure for an initiator and responder which have TX/RX beam reciprocity and which exchange announcement frames on a non-mmWave link to set up the initiator to transmit a BRP training PPDU sequence at the mmWave link and for the responder to provide feedback at the mmWave link in accordance with selected embodiments of the present disclosure.

FIG. 6 illustrates an example of a frame exchange sequence for an MLO-assisted BRP procedure for an initiator and responder which do not have TX/RX beam reciprocity and which exchange announcement frames on a non-mmWave link to set up the an initiator and responder to sequentially transmit respective BRP training PPDU sequences at the mmWave link, where the an initiator and responder subsequently provide feedback at the mmWave link in accordance with selected embodiments of the present disclosure.

FIG. 7 depicts a timing diagram wherein different types of BRP training PPDU sequences are used to perform beam tracking and refinement in accordance with selected embodiments of the present disclosure.

FIG. 8 illustrates a flow diagram of a technique for wireless communications in accordance with selected embodiments of the present disclosure.

### DETAILED DESCRIPTION

An analog beam training system, apparatus, and methodology are described for performing analog beamforming training to provide beam tracking for slow channel changes or beam refinement to an established mmWave link between a first wireless multi-link device (MLD) and a second wireless MLD by transmitting a first setup frame over a mmWave link between the first and second wireless MLDs, where the first setup frame is used to negotiate one or more training parameters for transmitting a beam refinement protocol (BRP) training PPDU sequence from the first wireless MLD over the mmWave link to the second wireless MLD, where the BRP training PPDU sequence will depend on the Tx/Rx beam reciprocity property, whether the first or second MLD is the BRP initiator, and the training field configuration. In selected embodiments, the first wireless MLD is an access point (AP) MLD (initiator), the second wireless MLD is a non-AP MLD (responder), and the one or more training parameters include the number of training PPDUs, the types of training PPDUs (e.g., for Tx beam training or Rx beam training or both), and the number of Tx and/or Rx beams. After transmitting the first setup frame and waiting for a predetermined delay, the first wireless MLD transmits the BRP training PPDU sequence over the mmWave link to the second wireless MLD in accordance with the one or more training parameters. In response, the second wireless MLD receives, detects, and measures a BRP training PPDU signal quality to determine a transmit beam ranking for the first wireless MLD and/or the corresponding receive beam ranking at the second wireless MLD. The second wireless MLD further transmits, via the mmWave or non-mmWave link, beam training feedback information regarding the transmit beam ranking based on BRP training PPDU sequence. In selected embodiments, the feedback containing the transmit beam ranking may be sent over mmWave link at the initiation of the second wireless MLD that received the BRP training PPDU sequence immediately, or in response to a beamforming (BF) polling packet sent by the first wireless MLD over the non-mmWave or mmWave link.

The various implementations described in the following description relate generally to millimeter wave (mmWave) and non-mmWave communications to support new wireless communication protocols, and more particularly to a procedure for establishing a mmWave link that is supported by a multi-link operation device to overcome the limitations and drawbacks of conventional standalone mmWave link beam refinement protocol (BRP) procedures associated with the IEEE 802.11ay or 802.11ad amendments. It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

In embodiments of a wireless communications system, an access point (AP) affiliated with an AP multi-link device (MLD) (e.g., wireless device) of a wireless local area network (WLAN) transmits data to at least one associated non-AP station (STA) affiliated with a non-AP STA MLD (e.g., a STA MLD). The AP MLD is configured to operate with associated non-AP MLDs according to a communication protocol. For example, the communication protocol may be an Ultra-High Reliability (UHR) communication protocol, IEEE 802.11be communication protocol, or future versions of such protocols that are being developed. Features of wireless communications and multi-link communication systems operating in accordance with the UHR communication protocol and/or next-generation communication protocols may incorporate support for operation in the millimeter-wave (mmWave) frequency bands, specifically the unlicensed bands between 42 GHz and 71 GHz, into mainstream Wi-Fi.

To support the use of mmWave frequency bands, the IEEE 802.11bq standard, also known as Integrated Millimeter Wave (IMMW), is a planned amendment to the IEEE 802.11 Wi-Fi standard which will incorporate support for operation in mmWave links to meet the demands of new applications, including but not limited to augmented and virtual reality, proximity ranging and sensing, both in terms of throughput, latency bounds and accuracy for the next generation WLAN. The primary goal of this amendment is to incorporate support for operation in the millimeter-wave (mmWave) frequency bands, specifically the unlicensed bands between 42 GHz and 71 GHz, into mainstream Wi-Fi. The direction for the IEEE 802.11bq standard is to minimize system complexity and simplify integration by expanding the multi-link operation (MLO) defined in the sub-7 GHz band (non-mmWave link) specification to incorporate support for operation in the millimeter-wave (mmWave) frequency bands, specifically the unlicensed bands between 42 GHz and 71 GHz, into mainstream Wi-Fi.

To support operation in the mmWave bands, the 802.11bq standard will be designed to enable “non-standalone operation,” meaning that a device supporting 802.11bq must be able to operate in the mmWave frequency band (e.g., 45 GHz or 60 GHz) and must also be able to operate at least one of the sub-7 GHz unlicensed bands (like 2.4 GHz, 5 GHz, and 6 GHz). It does so by leveraging or reusing existing Physical Layer (PHY) and Medium Access Control (MAC) specifications from the sub-7 GHz bands while also defining new bandwidth modes and coexistence mechanisms to work effectively in the higher mmWave frequencies. In addition, the IEEE 802.11bq standard will modify and improve the frame exchange procedures used to perform mmWave beam refinement protocol (BRP) training for training the receive and transmit antenna array(s) to improve the transmit (Tx) and receive (Rx) antenna configuration using an iterative procedure with BRP frame. For example, first and second wireless devices can negotiate and set up a BRP procedure whereby the first wireless device transmits BRP training packets over the mmWave link to the second wireless device, where the first wireless device can apply a different transmit beamforming pattern (or beam) when transmitting each BRP training packet. In particular, the disclosed BRP procedure can apply multiple Tx beams on each BRP training PPDU. For example, the non-training (TRN) part of a training BRP PPDU uses the best Tx beam obtained from the previous beamforming training/BRP procedure, and each training (TRN) field could be applied with different Tx beams of the transmitter/Rx beams of the receiver. In response, the second device generally determines which transmit beam of the first wireless device and/or receive beam of the second wireless device has the highest quality (e.g., having the highest signal-to-noise ratio (SNR) or receive signal strengths and notifies the first wireless device, which can then utilize the transmission beamforming pattern that yielded the highest quality packet. Similarly, to determine a receive beam to be applied by the first wireless device and/or transmit beam to be applied by the second wireless device when receiving data from the second wireless device, the second wireless device transmits BRP training packets to the first wireless device which may include the second wireless device applying multiple Tx beams in one BRP training PPDU, and the first wireless device applies a different beamforming pattern when receiving each BRP training packet. The first wireless device may determine which of the transmit beam of the second wireless device and/or receive beam of the first wireless device has the highest quality and utilize the receive beam that yields the highest quality packet. When multiple Tx/Rx RF chains (each connecting to an antenna array) are enabled, the digital beamforming training could be further conducted once the analog beaming with BRP procedure is done and the analog AWVs are applied on both Tx/Rx RF chains.

While the “BRP” terminology used to describe the iterative procedure with BRP training PPDUs to further train the MLD receive and transmit antenna array(s) for improving the transmit (Tx) and receive (Rx) antenna configuration on top of the initial SLS training process, the beam refinement terminology may change in future standards or revisions. However, for purposes of the present disclosure, the following terminology from the existing IEEE 802.11ay or 802.11ad standards will be used herein to describe the procedure to track or further refine the transmit and/or receive beams used by the AP-MLD and non-AP STA MLD over an existing mmWave link:
AWV (antenna weight vector)/Beam: A vector of weights or beam describing the excitation (amplitude and phase) for each element of an antenna array.
RF chain: Each RF chain could connect to one or multiple antenna arrays in the implementation, but only one antenna array is connected to the RF chain at a time; multiple RF chains can be used to transmit one or multiple data streams. In the later discussion, we may assume one RF chain is equivalent to an antenna array.
Beam index: Indicates one AWV of the RF chain or a Tx/Rx AWV pair for the corresponding Tx/Rx RF chain pair.
Tx Beam combination index: A Tx AWV/Beam combination of multiple Tx RF chains and the corresponding Rx RF chains for MIMO configuration, based on the previous feedback report. When one Tx RF chain is enabled, there is only one Tx AWV/Beam is used.
BRP: The procedure to track or further refine the Tx and/or Rx beam used by the AP-MLD and non-AP STA MLD over an existing mmWave link
BRP initiator: The STA that initiates the BRP procedure.
BRP responder: The recipient STA of the BRP initiator training PPDU.
BRP Training PPDU: The PPDU used for Tx or Rx beam training in BRP procedure
Training (TRN) field: Indicates the field in the BRP training PPDU used to apply different Tx or Rx beams for beam quality measurement. Multiple training fields will be included in the training PPDU to train different Tx or Rx beams.
Non-training fields: When the BRP training PPDU is used to train multiple Tx or Rx beams, indicates the fields which are not used for Tx or Rx beam training, e.g., the STF fields for packet detection, the SIG field for preamble configuration, etc.

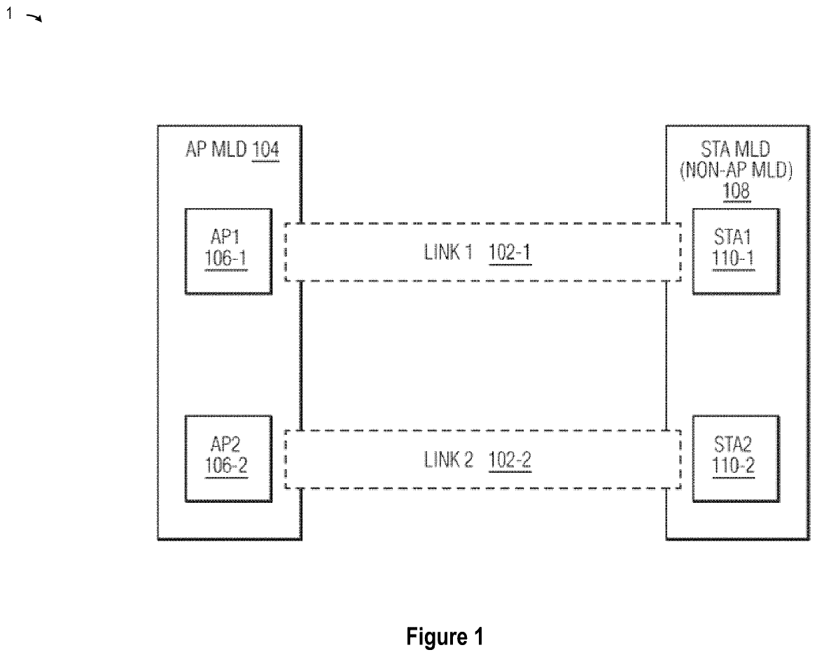

To provide an improved understanding of selected embodiments of the present disclosure, reference is now made to FIG. 1 which depicts a simplified block diagram of a multi-link communications system 1 that is used for wireless (e.g., WiFi) communications. As depicted, the multi-link communications system 1 includes one AP multi-link device (MLD) 104 and one non-AP STA MLD 108. The multi-link communications system 1 can be used in various applications, such as industrial applications, medical applications, computer applications, and/or consumer or enterprise applications. In some embodiments, the multi-link communications system 1 may be a wireless communications system, such as a wireless communications system compatible with an IEEE 802.11 protocol. For example, the multi-link communications system may be a wireless communications system compatible with an IEEE 802.11bq protocol. Although the depicted multi-link communications system 1 is shown with certain components and described with certain functionality herein, other embodiments of the multi-link communications system 1 may include fewer or more components to implement the same, less, or more functionality. For example, although the multi-link communications system 1 includes a single AP MLD 104 and a single STA MLD 108, in other embodiments, the multi-link communications system includes other multi-link devices, such as, multiple AP MLDs and multiple STA MLDs, multiple AP MLDs and a single STA MLD, a single AP MLD and multiple STA MLDs. In other embodiments, the multi-link communications system includes multiple STA MLDs and/or multiple AP MLDs. And while the multi-link communications system 1 is shown as being connected in a certain topology, the network topology of the multi-link communications system 1 is not limited to the depicted.

The depicted AP MLD 104 includes two radios, AP1 106-1 and AP2 106-2. In some embodiments, the AP MLD 104 is an AP multi-link logical device or an AP multi-link logical entity (MLLE). In selected embodiments, a common part of the AP MLD 104 implements upper layer Media Access Control (MAC) functionalities (e.g., beaconing, association establishment, reordering of frames, etc.) and a link-specific part of the AP MLD 104 (i.e., the APs 106-1, 106-2) implements lower layer MAC functionalities (e.g., backoff, frame transmission, frame reception, etc.). The APs 106-1, 106-2 may be implemented in hardware (e.g., circuits), software, firmware, or a combination thereof. The APs 106-1, 106-2 may be fully or partially implemented as an integrated circuit (IC) device. In some embodiments, the APs 106-1, 106-2 may be wireless APs compatible with at least one WLAN communications protocol (e.g., at least one IEEE 802.11 protocol). For example, the APs 106-1, 106-2 may be wireless APs compatible with an IEEE 802.11bq protocol.

In selected embodiments, an AP MLD 104 connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 106-1, and/or AP2 106-2) includes a plurality of antennas, at least one transceiver operably connected to the plurality of antennas, and at least one controller operably connected to the corresponding transceiver. In some embodiments, at least one transceiver includes a physical layer (PHY) device. The at least one controller may be configured to control the at least one transceiver to process received packets through the plurality of antennas. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 106-1, 106-2 may operate in different frequency bands. For example, at least one of the APs 106-1, 106-2 of the AP MLD 104 may operate in an Extremely High Frequency (EHF) band or the “millimeter wave (mmWave)” frequency band. In selected embodiments, the mmWave frequency band is a frequency band between 20 Gigahertz (GHz) and 300 GHz. For example, the mmWave is a frequency band above 45 GHz, (e.g., a 60 GHz frequency band). In addition, at least one of the APs 106-1, 106-2 of the AP MLD 104 may operate at a non-mmWave frequency band, such as a 5 Gigahertz (GHz) band (e.g., in a 320 MHz (one million hertz) Basic Service Set (BSS) operating channel or other suitable BSS operating channel). Although the AP MLD 104 is shown as including two APs, other embodiments of the AP MLD 104 may include more than two APs.

In similar fashion, the depicted non-AP STA multi-link device 108 includes two radios which are implemented as non-AP STAs, STA1 110-1 and STA2 110-2. The STAs 110-1, 110-2 may be implemented in hardware (e.g., circuits), software, firmware, or a combination thereof. One or more of the STAs 110-1, 110-2 may be fully or partially implemented as an IC device. In some embodiments, the non-AP STAs 110-1, 110-2 are part of the STA MLD 108, such that the STA MLD may be a communications device that wirelessly connects to a wireless AP MLD. For example, the STA MLD 108 may be implemented in a laptop, a desktop personal computer (PC), a mobile phone, or other communications device that supports at least one WLAN communications protocol. In some embodiments, the non-AP STA MLD 108 is a communications device compatible with at least one IEEE 802.11 protocol (e.g., an IEEE 802.11bq protocol). In some embodiments, the STA MLD 108 implements a common MAC data service interface and the non-AP STAs 110-1, 110-2 implement a lower layer MAC data service interface.

In some embodiments, the AP MLD 104 and/or the STA MLD 108 may identify which communication links support multi-link operation during a multi-link operation setup phase and/or exchanges information regarding multi-link capabilities during the multi-link operation setup phase. In some embodiments, each of the non-AP STAs 110-1, 110-2 of the STA MLD 108 may operate in a different frequency band. For example, the non-AP STA 110-1 may operate in the 5 GHz frequency band and the non-AP STA 110-2 may operate in the 60 GHz frequency band. In some embodiments, each STA includes a plurality of antennas, at least one transceiver operably connected to the plurality of antennas, and at least one controller connected to the corresponding transceiver. In some embodiments, at least one transceiver includes a PHY device. The at least one controller may be configured to control the at least one transceiver to process received packets through the plurality of antennas. In some embodiments, the at least one controller may be implemented within a processor, such as a microcontroller, a host processor, a host, a DSP, or a CPU, which can be integrated in a corresponding transceiver. In selected embodiments, the STA MLD 108 has one MAC data service interface. In other selected embodiments, the STA MLD 108 implements a common MAC data service interface and the non-AP STAs 110-1, 110-2 implement a lower layer MAC data service interface. In selected embodiments, the AP MLD 104 and/or the STA MLD(s) 108 identify which communications links support the multi-link operation during a multi-link operation setup phase and/or exchanges information regarding multi-link capabilities during the multi-link operation setup phase. Each of the STAs 110-1, 110-2 of the STA MLD 108 may operate in a different frequency band. For example, at least one of the STAs 110-1, 110-2 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. In addition, at least one of the APs 106-1, 106-2 of the AP MLD 104 may operate at a non-mmWave frequency band, such as 5 GHz band (e.g., in a 320 MHz (one million hertz) BSS operating channel or other suitable BSS operating channel). Although the STA MLD 108 is shown as including two non-AP STAs, additional non-AP STAs may be included.

In operation, the STA MLD 108 communicates with the AP MLD 104 via two communication links, link 1 102-1 and link 2 102-2. For example, each of the non-AP STAs 110-1, 110-2 communicates with an AP 106-1, 106-2 via corresponding communication links 102-1, 102-2. In an embodiment, a communication link (e.g., link 1 102-1 or link 2 102-2) may include a first operating channel established by an AP (e.g., AP1 106-1 or AP2 106-2) that is used to transmit frames (e.g., Physical Layer Convergence Protocol (PLCP) Protocol Data Units (PPDUs), Beacon frames, management frames, etc.) between a first wireless device (e.g., an AP, an AP MLD, an STA, or an STA MLD) and a second wireless device (e.g., an AP, an AP MLD, an STA, or an STA MLD). Although the STA MLD 108 is shown as including two non-AP STAs 110-1, 110-2, other embodiments of the STA MLD 108 may include one non-AP STA or more than two non-AP STAs. In addition, although the AP MLD 104 communicates (e.g., wirelessly communicates) with the STA MLD 108 via the communications links 102-1, 102-2, in other embodiments, the AP MLD 104 may communicate (e.g., wirelessly communicate) with the STA MLD 108 via more than two communication links. As disclosed herein, the communications links 102-1, 102-2 between the AP MLD 104 and the STA MLD 108 include at least one mmWave link and one non-mmWave link. For example, the communications links 102-1, 102-2 may include an mmWave link (e.g., a 45/60 GHz link) between an AP 106-1 of the AP MLD 104 and an STA 110-1 of the STA MLD 108 operating in a mmWave frequency band (e.g., a 45/60 GHz frequency band) and may also include a non-mmWave link (e.g., 2.4 GHz, 5 GHz, or 6 GHz links) between another AP 106-2 of the AP MLD 104 and an STA 110-2 of the STA MLD 108 operating in non-mmWave frequency bands (e.g., 2.4 GHz, 5 GHz, or 6 GHz frequency bands). The control and management of an mmWave link, for example, a 45 GHz/60 GHz link may be performed by having an initiator MLD (e.g., an AP MLD 104 or non-AP MLD (STA MLD) 108)) send management/control information in a non-mmWave link, for example, a 2.4 GHz, 5 GHz, or 6 GHz link. For example, the association of a non-AP MLD with an mmWave link can be done through a non-mmWave MHz link.

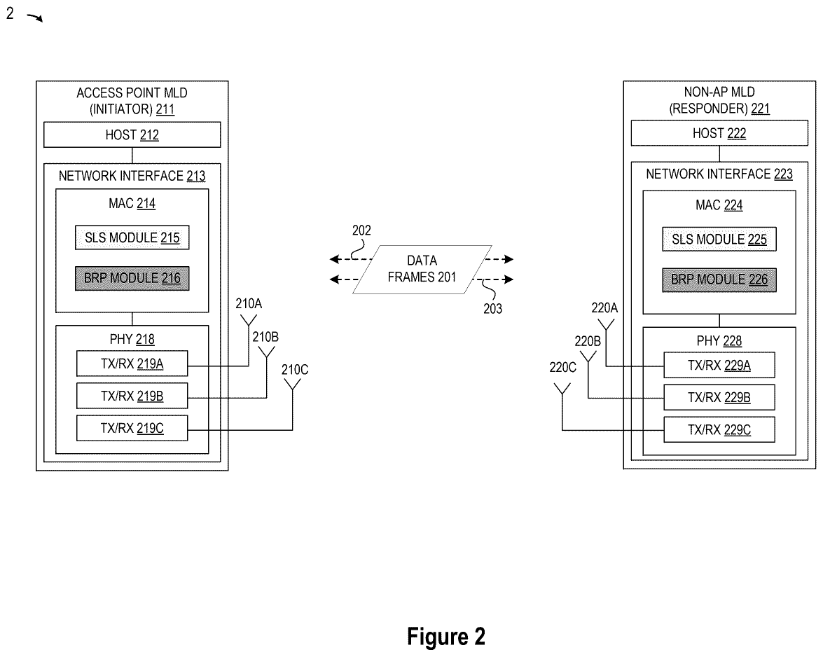

To provide an improved understanding of selected embodiments of the present disclosure, reference is now made to FIG. 2 is a simplified block diagram of a wireless communications system 2, such as a wireless local area network (WLAN), in which a transmitter access point (AP) MLD 211 and one or more wireless non-AP MLDs 221 use beamforming to transmit and receive data packets. As depicted, the AP MLD 211 includes a host processor 212 coupled to a network interface 213. In selected embodiments, the network interface 213 includes one or more integrated circuits (IC) devices configured to operate a local area network (LAN) protocol. To this end, the network interface 213 may include a medium access control (MAC) processor 214 and a physical layer (PHY) processor 218. In selected embodiments, the MAC processor 214 is implemented as an 802.11bq MAC processor 214, and the PHY processor 218 is implemented as an 802.11bq PHY processor 218. The PHY processor 218 includes a plurality of transceivers 219A-C which are coupled to a plurality of antennas 210A-C. Although three transceivers 219A-C and three antennas 210A-C are illustrated, the AP MLD 211 may use any suitable number of transceivers 219 and antennas 210 in other embodiments. In addition, the AP MLD 211 may have more antennas 210 than transceivers 219, in which case antenna switching techniques are used to switch the antennas 210 between the transceivers 219. In selected embodiments, the MAC processor 214 is implemented with one or more integrated circuit (IC) devices, and the PHY processor 218 is implemented on one or more additional IC devices. In other embodiments, at least a portion of the MAC processor 214 and at least a portion of the PHY processor 218 are implemented on a single IC device. In various embodiments, the MAC processor 214 and the PHY processor 218 are configured to operate according to at least a first communication protocol (e.g., 802.11bq). In other embodiments, the MAC processor 214 and the PHY processor 218 are also configured to operate according to one or more additional communication protocols (e.g., according to the IEEE 802.11bn Standard). Using the communication protocol(s), the AP MLD 211 is operative to create a wireless local area network (WLAN) in which one or more client stations (e.g., 221) may communicate with the AP MLD 211 and/or with other client stations (not shown) located within the WLAN. Although a single client station 221 is illustrated in FIG. 2, the WLAN may include any suitable number of client stations in various scenarios and embodiments.

As depicted, the wireless non-AP MLD 221 includes a host processor 222 coupled to a network interface 223. In selected embodiments, the network interface 223 includes one or more IC devices configured to operate as discussed below. For example, the depicted network interface 223 may include a MAC processor 224 and a PHY processor 228. In selected embodiments, the MAC processor 224 is implemented as an 802.11bq MAC processor 224, and the PHY processor 228 is implemented as an 802.11bq PHY processor 228. The PHY processor 228 includes a plurality of transceivers 229A-C coupled to a plurality of antennas 220A-C. Although three transceivers 229A-C and three antennas 220A-C are illustrated, the receiver STA 21 may include any suitable number of transceivers 229 and antennas 220. In addition, the non-AP MLD 221 may include more antenna arrays than transceivers, in which case antenna array switching techniques are used. In selected embodiments, the MAC processor 224 is implemented on at least a first IC device, and the PHY processor 228 is implemented on at least a second IC device. In other embodiment, at least a portion of the MAC processor 224 and at least a portion of the PHY processor 228 are implemented on a single IC device.

In operation, the AP MLD 211 is configured to transmit or exchange data frames 201 with the non-AP MLD 221 over a mmWave link 202 by using beamforming with antenna arrays 210 to compensate for the high pathloss. To this end, each initiator STA device (e.g., AP MLD 211) includes an SLS module 215 which is configured to perform an initial sector level sweep (SLS) operation to find initial antenna weight vectors (AWV) or beamforming weights for analog beamforming to enable the AP MLD 211 and non-AP MLD 221 to communicate. In particular, the SLS module 215 configures the PHY processor 218 and transmit antennas 210 to perform a coarse search to find the best directional beam for communicating with the non-AP MLD 221 by sweeping through a set of predefined beams to find the one with the strongest signal. In selected embodiments, this is performed by transmitting a plurality of SLS training packets (or training PPDUs) to the responder device (e.g., non-AP MLD 221) with a different beamforming pattern applied when transmitting each SLS training packet.

Once a coarse beam is selected by the SLS module 215, a more detailed process begins to “refine” the beam. To this end, each initiator STA device (e.g., AP MLD 211) may include a beam refinement protocol (BRP) module 216 which is configured to further train the device receive and transmit antenna array(s) and improve its transmit (Tx) and receive (Rx) antenna configuration on top of SLS. In particular, the BRP module 216 configures the PHY processor 218 and transmit antennas 210 to perform a beam refinement search, such as by performing sub-beam sweeping or fine-tuning the phase and amplitude of the signals transmitted from each antenna element. In selected embodiments, this is performed by transmitting a plurality of BRP training packets (or training PPDUs) to the non-AP MLD 221 with a different beamforming pattern applied when transmitting each BRP training packet. In other embodiments, the transmitter can apply different Tx beams to different training fields of a BRP training PPDU, and the receiver can apply different Rx beams at different training fields of a BRP training PPDU.

In turn, the non-AP MLD 221 is configured to receive or exchange data frames 201 with the AP MLD 221 over a mmWave link 202 by using beamforming with antenna arrays 220 to compensate for the high pathloss. To this end, each responder STA device (e.g., non-AP MLD 221) includes an SLS module 225 and BRP module 226 which respectively perform the reception processing functions for the SLS operations, BRP operations, and more. In particular, the SLS module 225 is configured to measure SLS training PPDU signal quality values to determine a transmit beam ranking from the plurality of SLS training packets transmitted to the non-AP MLD 221. Similarly, the BRP module 226 is configured to measure BRP training PPDU signal quality values to determine a transmit beam ranking from the plurality of BRP training packets transmitted to the non-AP MLD 221. As disclosed herein, the beamforming training can have two directions in cases where there is no Tx/Rx beam is not reciprocity. In the direction of initiator Tx, the initiator trains Tx beams and the responder can train the Rx beams. In the reverse direction, the previous responder trains Tx beams, and the previous initiator trains Rx beams. In addition, if the two direction trainings are separately initiated, the device that initiates the training PPDU transmission may be identified as the “initiator.”

To address the existing shortcomings of the existing 802.11 capabilities, the BRP modules 216, 226 provide an improved BRP procedure at each STA device which uses an MLO process to periodically initiate a BRP procedure for transmitting a BRP training PPDU sequence on the mmWave link and providing feedback messages on the mmWave link packet exchange. In particular and as described more fully hereinbelow, the BRP module 216 is configured to do beam tracking and refinement on a mmWave link 202 by performing an MLO-assisted BRP procedure that is initiated right after the SLS procedure establishes the mmWave link 202, and will then be initiated periodically or on demand by the receiver (e.g., when the beam failure is detected) to do beam tracking and refinement. In addition, if the BRP procedure is initiated per receiver trigger, the BRP module 216 can be configured to train a limited set of candidate beams or a new round of BRP beams with both coarse and fine beams.

In particular and as described more fully hereinbelow, the BRP module 216 may be configured to perform an initiation step by using at least an announcement (or setup) frame exchange to negotiate and set up the BRP procedure. In addition, the BRP module 216 may be configured to perform a BRP training step by transmitting a BRP training PPDU sequence in the mmWave link 202 following the announcement frame exchange after a specified delay time. Finally, the BRP module 216 may be configured to perform a feedback step by receiving one or more BRP feedback frames in the mmWave link 202 or non-mmWave link 203. When multi-link operation is available, the link usage of these steps for the BRP procedure can be determined based on the availability of the information on the best available Tx/Rx AWV pair used to connect the mmWave link 202 between the BRP initiator (e.g., AP STA MLD 211) and the BRP responder (e.g., and non-AP MLD 221) at each step. For example, in a first BRP initiation option when the information of the best available Tx/Rx AWV pair is negotiated before the announcement frame exchange via a special control or management frame exchange on the non-mmWave link 203, then all three steps (initiation, BRP training, and feedback) can be performed on the mmWave link 202. However, in a second BRP initiation option when the information of the best available Tx/Rx AWV pair is negotiated in the announcement frame exchange of the initiation step, then the initiation step needs to start from the non-mmWave link 203, and the BRP training and feedback steps are performed on the mmWave link 202.

Under control of the BRP modules 216, 226, the AP STA MLD 211 and non-AP MLD 221 perform the initiation step to negotiate the training parameters for the BRP training PPDU sequence to be sent over the mmWave link 202, including the best available Tx/Rx AWV pair used with the mmWave link 202 (if not previously negotiated), number of BRP training PPDUs, the types of training PPDUs (e.g., for Tx beam training or Rx beam training or both), and the TRN field configuration including the number of Tx and/or Rx beams, etc.

Based on the training parameters, the BRP modules 216, 226 are configured to generate the BRP training PPDU sequence. For example, based on the Tx/Rx beam reciprocity, the BRP module 216 may be configured to transmit the BRP training PPDU sequence only in one direction on the mmWave link 202. In other embodiments of the present disclosure, the BRP module 216 is configured to specify a BRP training PPDU sequence wherein one or more additional training (TRN) fields could be added in each training PPDU to evaluate either the transmit or receive AWVs or both to improve the training efficiency. In such embodiments, the TRN field structure may use a similar TRN field structure as in the EDMG BRP PPDU design specified in the 802.11me maintenance task group (e.g., IEEE P802.11-REVme/D4.0, August 2023) for OFDM, but leveraging the PPDU format in sub-7 GHz and could use the similar LTF sequence design as in the sub-7 GHz PPDU format for the TRN field. To enhance the detection of BRP training PPDU sequences, the best available Tx/Rx AWV/beam pair negotiated with or before the announcement frame exchange are applied to the non-TRN fields, and different Tx/Rx AWVs can be applied to the TRN fields

Depending on the TRN field configuration, the BRP module 216 could be configured to perform different types of BRP training based on the different training purposes. In addition, the training period for each type could be different. For example, a first BRP training type performs joint training for both Tx and Rx AWVs which can be done in one or multiple training PPDUs. In addition, a second BRP training type performs Tx beam refinement with the best Rx AWV applied at the receiver. And a third BRP training type performs Rx beam refinement with the best Tx AWV applied at the transmitter. When there are multiple transmit RF chains, the BRP module 216 could have the option to configure TRN fields to train multiple transmit RF chains independently or simultaneously.

As will be appreciated, the BRP module 226 at the responder (e.g., non-AP MLD 221) may be configured to detect the BRP training PPDU sequence and to measure the training PPDU receive quality to determine the quality of corresponding Tx beam used by the initiator (e.g., AP MLD 211). In such embodiments, the BRP module 226 may be configured to send a feedback message containing the Tx beam quality ranking via the mmWave link. In selected embodiments, the feedback message may be initiated by the responder in response to receiving the BRP training PPDU sequence. For example, if the BRP module 216 at the initiator (e.g., 211) is configured to perform joint training for both Tx and Rx AWVs, then the BRP module 226 at the responder (e.g., 221) may be configured to transmit a BRP feedback frame to the initiator (e.g., 211). Likewise, if the BRP module 216 at the initiator (e.g., 211) is configured to perform Tx beam refinement with the best Rx AWV applied at the responder, then the BRP module 226 at the responder (e.g., 221) may be configured to transmit a BRP feedback frame to the initiator (e.g., 211). However, for the third BRP training type which performs Rx beam refinement with the best Tx AWV applied at the transmitter, there is no need for the BRP module 226 to generate a BRP feedback frame.

As disclosed herein, there can be differences in the MLO-assisted BRP procedure implemented by the BRP modules 216, 226, depending on whether the access point (AP) STA (e.g., AP MLD 211)) or a non-AP STA (e.g., non-AP MLD 221) is the initiator to start the BRP procedure. While the present disclosure is provided with reference to the initiator being an AP (MLD) that initiates the BRP procedure with a control frame and/or an announcement frame (i.e., NDPA) and generates a BRP training PPDU sequence, it will be appreciated that the initiator can be a non-AP STA (MLD) which uses other options for initiating the BRP procedure. For example, an announcement frame may have another name, especially if the training PPDU is not in the NDP format. And while the present disclosure is provided with reference to the non-mmWave link being a 5 GHz band and the mmWave link being a 60 GHz band, it will be appreciated that other non-mmWave bands below 7 GHz can be used, and that other mmWave bands between 42 GHz and 71 GHz can be used.

### BRP Initiation Option With Announcement Frame Exchange in mmWave Link

In selected embodiments of the present disclosure, there are disclosed various frame exchange sequences for an MLO-assisted BRP procedure which are initiated with a control or management frame exchange (namely, CF1/CF2) at the non-mmWave link to inform the best Tx AWV/Beam to be used by the initiator STA for the next BRP training PPDU sequence at the mmWave link to allow the responder STA to know the corresponding Rx AWV/beam for packet detection. In such embodiments, both the initiator STA and responder STA may use the Tx/Rx beams exchanged in the CF1/CF2 exchange during the whole BRP procedure for packet detection until the BRP feedback is received, except for the TRN fields of the BRP training PPDU sequence. In addition, the announcement frame, feedback frame and training PPDU preamble part can set the PPDU format/bandwidth to be the same as the one used in the previously performed SLS procedure to have the best sensitivity. However, the control or management frame exchange can be skipped in selected embodiments where the mmWave link already has the Tx/Rx AWV information for the announcement frame, BRP feedback, and training PPDU packet detection in both directions.

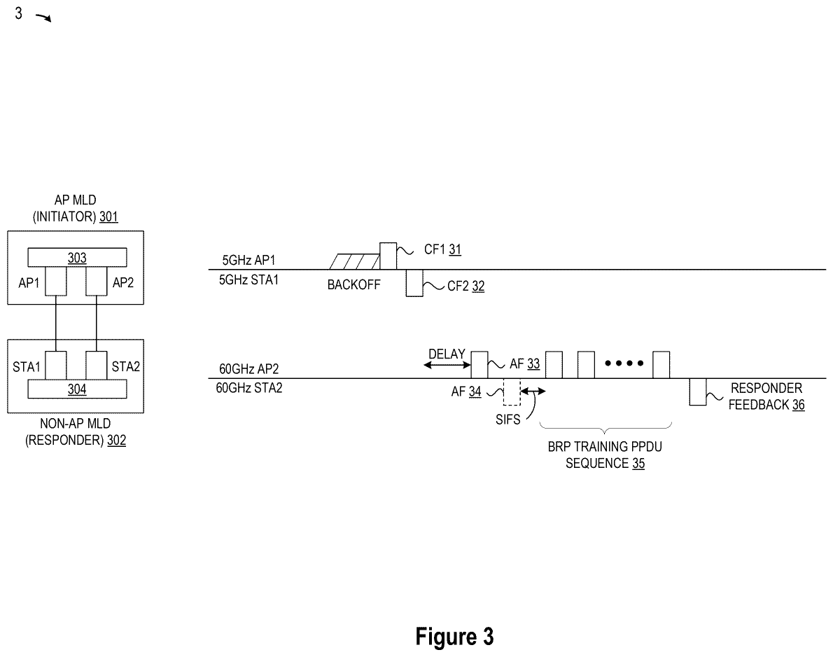

To provide additional details for an improved understanding of selected embodiments of the present disclosure, reference is now made to FIG. 3 which depicts a first case example of a frame exchange sequence for an MLO-assisted BRP procedure 3 for an initiator (AP MLD) 301 and a responder (non-AP MLD) 302 which have TX/RX beam reciprocity and which exchange control frames (CF1, CF2) on a non-mmWave link to set up an announcement frame exchange on the mmWave link for the initiator to transmit a BRP training PPDU sequence at the mmWave link to the responder, where a first responder feedback option is provided at the mmWave link immediately after the last BRP training PPDU or with a delay by solicitation. As seen, the timing of the responder feedback depends on the responder implementation capability on how quickly the feedback is available. In the depicted MLO-assisted BRP procedure 3, the frames CF1 31, CF2 32 are exchanged between an AP MLD 301 (which includes a common MAC controller 303 and two wireless APs AP1, AP2) and a non-AP MLD 302 (which includes a common MAC controller 304 and two wireless STAs STA1, STA2). In selected embodiments, the common MAC controller 303 implements upper layer MAC functionalities (e.g., association establishment, etc.) of the AP MLD 301, and a link specific part of the AP MLD 301 (i.e., AP1, AP2) implements lower layer MAC functionalities (e.g., backoff, frame transmission, frame reception, etc.) of the AP MLD 301. In similar fashion, the common MAC controller 304 implements upper layer MAC functionalities (e.g., association establishment, etc.) of the non-AP MLD 302 and a link specific part of the non-AP MLD 302 (i.e., STA1, STA2) implements lower layer MAC functionalities (e.g., backoff, frame transmission, frame reception, etc.) of the non-AP MLD 302. The AP MLD 301 may be implemented in an embodiment with the AP MLD 211 depicted in FIG. 2, but may be implemented with any suitable controller design, such as a host processor and network interface connected to a MAC processor and PHY processor. Likewise, the non-AP MLD 302 may be implemented in an embodiment with the non-AP MLD 221 depicted in FIG. 2, but may be implemented with any suitable controller design, such as a host processor and network interface connected to a MAC processor and PHY processor.

In the example frame exchange sequence for an MLO-assisted BRP procedure 3, after an initial backoff period expires (i.e., backoff counter becomes zero), AP1 transmits a first control/management frame CF1 31 to STA 1 through the non-mmWave link (e.g., a 5 GHz band link) between AP1 and STA1, and STA1 replies by transmitting a second control/management (response) frame CF2 32 through the non-mmWave link. Through this frame exchange, the information of the best available Tx AWV information for AP2 and STA2 transmission during the BRP procedure is negotiated. The initiator and the responder (e.g., AP2 and STA2, respectively) negotiate a delay time (DELAY) required between the end of the control frame exchange and the start of an announcement frame exchange in a mmWave link (e.g., a 60 GHz band link) between AP2 and STA2. The negotiated time and the end time of the control frame exchange decide when the announcement frame exchange in the mmWave link starts. After the delay time, AP2 transmits a first announcement frame 33 to STA2 through the mmWave link (e.g., a 60 GHz band link) between AP2 and STA2, and STA2 replies by transmitting a second announcement (response) frame 34 through the mmWave link. At a specified time duration (e.g., a short interframe space (SIFS)) after the announcement frame packet exchange 33, 34, both the initiator (AP2) and responder (STA2) on the mmWave link are ready to do the beam training such that an BRP training PPDU sequence 35 is communicated or conducted through the mmWave link (e.g., a 60 GHz band link) between AP2 and STA2. As disclosed, the BRP training PPDU sequence 35 is sent to train the negotiated number of Tx and/or Rx beams. After the BRP training PPDU sequence 35 is completed and the STA2 transmits a responder feedback message 36 to AP2 through the mmWave link (e.g., a 60 GHz band link). In selected embodiments, the second announcement (response) frame 34 may be skipped (as indicated with the dashed lines) if the BRP training PPDU sequence 35 is only used for the training of AP2 transmit beams with the STA2 receive beam fixed, where no additional information is needed from the second announcement (response) frame 34.

In the depicted frame exchange sequence for an MLO-assisted BRP procedure 3, there is a mmWave link (e.g., a 45 GHz link or a 60 GHz link) between the AP2 and STA2 which operates in a mmWave frequency band (e.g., a 45 GHz or 60 GHz frequency band) and which is capable of mmWave communications. In addition, there is a non-mmWave link (e.g., a 2.4/5/6 GHz band link) between AP1 and STA1, which operates in a non-mmWave frequency band (e.g., a 2.4 GHz, 5 GHz, or 6 GHz frequency band) and which is capable of non-mmWave communications. Although the AP MLD 301 is shown with two APs, other embodiments of the AP MLD 301 may include fewer or more APs. In addition, although the non-AP MLD 302 is shown with two non-AP STAs, other embodiments of the non-AP MLD 302 may include fewer or more non-AP STAs.

In the depicted first case example of a frame exchange sequence for an MLO-assisted BRP procedure 3, the initiator 301 and responder 302 have Tx/Rx beam reciprocity which may be signaled via the Link Capability signal information which the MLDs exchange during the setup process to inform each other about their multi-link abilities. With Tx/Rx beam reciprocity, the best Tx AWV can be used as the Rx AWV for the initiator 301. The best Rx AWV can be used as the Tx AWV for the responder 302, and the BRP is done after a valid responder feedback message 36 is received by initiator 301. In the depicted MLO-assisted BRP procedure 3, the feedback frame could be an immediate or delayed feedback sent by the responder 302 on the mmWave link or the non-mmWave link after the BRP training PPDU sequence 35 or in response to a BF polling packet sent by the initiator 301 over the non-mmWave or mmWave link.

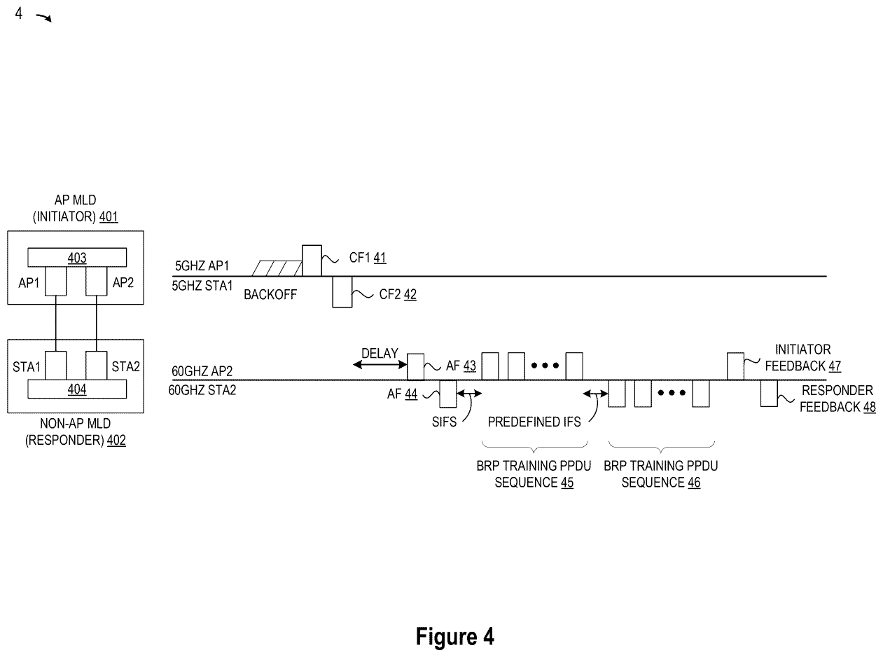

To provide additional details for an improved understanding of selected embodiments of the present disclosure, reference is now made to FIG. 4 which depicts a second case example of a frame exchange sequence for an MLO-assisted BRP procedure 4 for an initiator (AP MLD) 401 and a responder (non-AP MLD) 402 which do not have TX/RX beam reciprocity and which exchange control/management frames (e.g., CF1/CF2) on a non-mmWave link to set up an announcement frame exchange on the mmWave link for the initiator and responder to sequentially transmit respective BRP training PPDU sequences at the mmWave link, where the initiator and responder subsequently provide feedback at the mmWave link. In the depicted MLO-assisted BRP procedure 4, frames are exchanged between an AP MLD 401 (which includes a common MAC controller 403 and two wireless APs AP1, AP2) and a non-AP MLD 402 (which includes a common MAC controller 404 and two wireless STAs STA1, STA2). In selected embodiments, the common MAC controller 403 implements upper layer MAC functionalities of the AP MLD 401, and a link specific part of the AP MLD 401 (i.e., AP1, AP2) implements lower layer MAC functionalities of the AP MLD 401. In similar fashion, the common MAC controller 404 implements upper layer MAC functionalities of the non-AP MLD 402, and a link specific part of the non-AP MLD 402 (i.e., STA1, STA2) implements lower layer MAC functionalities of the non-AP MLD 402. As will be appreciated, the AP MLD 401 and non-AP MLD 402 may be implemented with any suitable controller design, such as a host processor and network interface connected to a MAC processor and PHY processor.

In the example frame exchange sequence for an MLO-assisted BRP procedure 4 where the initiator (AP MLD 401) and responder (non-AP MLD 402) do not have the Tx/Rx beam reciprocity, the responder's BRP training PPDU sequence 46 will follow after the initiator's BRP training PPDU sequence 45. In particular, the example frame exchange sequence for the MLO-assisted BRP procedure 4 starts after an initial backoff period expires (i.e., backoff counter becomes zero) when AP1 transmits a first control/management frame CF1 41 to STA 1 through the non-mmWave link (e.g., a 5 GHz band link) between AP1 and STA1, and STA1 replies by transmitting a second control/management (response) frame CF2 42 through the non-mmWave link. Through the control/management frame exchange, the information of the best available Tx AWV information for AP2 and STA2 transmission during the BRP procedure is negotiated. Next, the initiator and the responder (e.g., AP2 and STA2, respectively) negotiate a delay time (DELAY) required between the end of the control frame exchange and the start of an announcement frame exchange in a mmWave link (e.g., a 60 GHz band link) between AP2 and STA2. The negotiated time and the end time of the control frame exchange decide when the announcement frame exchange in the mmWave link starts. After the delay time, AP2 transmits a first announcement frame 43 to STA2 through the mmWave link (e.g., a 60 GHz band link) between AP2 and STA2, and STA2 replies by transmitting a second announcement (response) frame 44 through the mmWave link. At a specified time duration (e.g., a short interframe space (SIFS)) after the announcement frame packet exchange 43, 44, both the initiator (AP2) and responder (STA2) on the mmWave link are ready to do the beam training through the mmWave link (e.g., a 60 GHz band link) by transmitting the BRP training PPDU sequence 45 between AP2 and STA2, and then transmitting the BRP training PPDU sequence 46 between STA2 and AP2. In selected embodiments, the responder BRP training PPDU sequence 46 can be sent out after the initiator BRP training PPDU sequence 45 with a predefined interframe space (IFS). In other embodiments (not shown), the initiator BRP procedure and the responder BRP procedure can be independently initiated within their own TXOP. After the responder BRP training PPDU sequence 46 is completed, the initiator (AP2) transmits an initiator feedback message 47 to STA2 through the mmWave link (e.g., a 60 GHz band link), followed by the responder (STA2) transmitting a responder feedback message 48 to AP2 through the mmWave link. Though the sequential transmission of BRP training PPDU sequences 45, 46 and BRP feedback frames 47, 48 can be communicated or conducted through the mmWave link in response to a single announcement frame exchange, separate announcement frame exchanges can be used so that a first announcement frame exchange is used to initiate the initiator BRP training PPDU sequence and responder feedback frame, and a second announcement (response) frame exchange is used to initiate the responder BRP training PPDU sequence and initiator feedback frame. Alternatively, the BRP feedback frames 47, 48 can be sent in response to a BF polling packet sent by the responder 402 or initiator 401 respectively over the non-mmWave or mmWave link. As disclosed herein, the BRP feedback frames can also be sent on the non-mmWave link via medium access for both initiator and responder, sequentially or independently.

### BRP Initiation Option With Announcement Frame Exchange in Non-mmWave Link

In selected embodiments of the present disclosure, there are disclosed various frame exchange sequences for an MLO-assisted BRP procedure which are initiated with an announcement frame (AF) exchange at the non-mmWave link to negotiate the BRP training parameters including the best Tx AWV/Beam to be used by the initiator/responder STAs for the next BRP training PPDU sequence and feedback frame at the mmWave link. In such embodiments, the both the initiator STA and responder STA may use the Tx/Rx beams negotiated in the announcement frame exchange during the whole BRP procedure in the mmWave link until the BRP feedback is received, except for the TRN fields of the BRP training PPDU sequence.

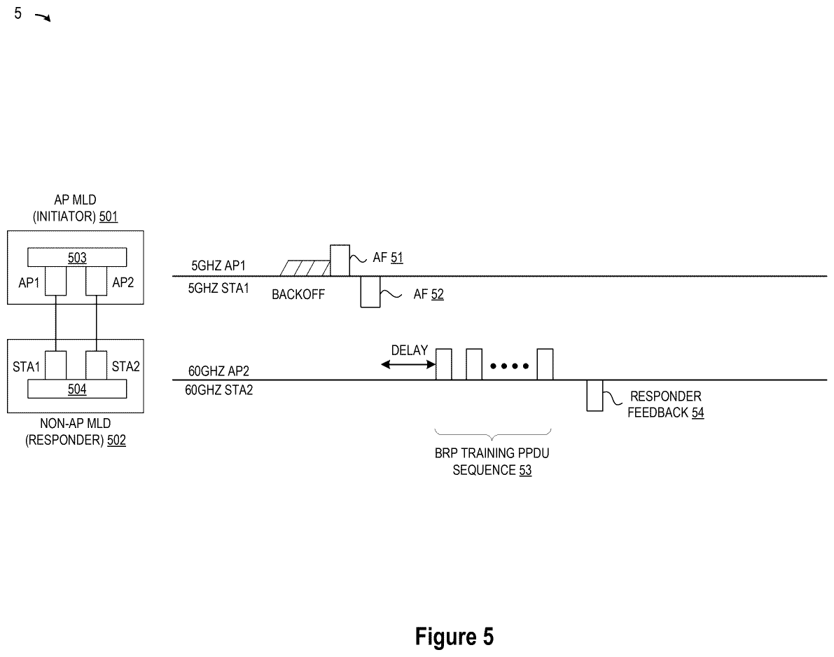

To provide additional details for an improved understanding of selected embodiments of the present disclosure, reference is now made to FIG. 5 which depicts a first case example of a frame exchange sequence for an MLO-assisted BRP procedure 5 for an initiator (AP MLD) 501 and a responder (non-AP MLD) 502 which have TX/RX beam reciprocity and which exchange announcement frames (AF) 51, 52 on a non-mmWave link to set up the initiator to transmit a BRP training PPDU sequence 53 at the mmWave link and for the responder to provide feedback 54 at the mmWave link. In the depicted MLO-assisted BRP procedure 5, frames are exchanged between an AP MLD 501 (which includes a common MAC controller 503 and two wireless APs AP1, AP2) and a non-AP MLD 502 (which includes a common MAC controller 504 and two wireless STAs STA1, STA2). In selected embodiments, the common MAC controller 503 implements upper layer MAC functionalities of the AP MLD 501, and a link specific part of the AP MLD 501 (i.e., AP1, AP2) implements lower layer MAC functionalities of the AP MLD 501. In similar fashion, the common MAC controller 504 implements upper layer MAC functionalities of the non-AP MLD 502, and a link specific part of the non-AP MLD 502 (i.e., STA1, STA2) implements lower layer MAC functionalities of the non-AP MLD 502. As will be appreciated, the AP MLD 501 and non-AP MLD 502 may be implemented with any suitable controller design, such as a host processor and network interface connected to a MAC processor and PHY processor.

In the example frame exchange sequence for an MLO-assisted BRP procedure 5, after an initial backoff period expires (i.e., backoff counter becomes zero), AP1 transmits a first announcement frame AF 51 to STA1 through the non-mmWave link (e.g., a 5 GHz band link) between AP1 and STA1, and STA1 replies by transmitting a second announcement (response) frame 52 through the non-mmWave link. Through the announcement frame exchange, the information of the best available Tx AWV information for AP2 and STA2 transmission during the BRP procedure is negotiated. The initiator and the responder (e.g., AP2 and STA2, respectively) negotiate a delay time (DELAY) required between the end of the announcement frame exchange and the start of beam training in a mmWave link (e.g., a 60 GHz band link) between AP2 and STA2. As disclosed herein, the delay between AF packet exchange 51, 52 in non-mmWave link and the BRP training PPDU transmission 53 in the mmWave link could be: (1) a predefined IFS if the medium is available, (2) a medium access time with backoff based on the medium availability status according to clear channel assessment (CCA) function. After the delay time, both the initiator (AP2) and responder (STA2) on the mmWave link are ready to do the beam training such that an BRP training PPDU sequence 53 is communicated or conducted through the mmWave link (e.g., a 60 GHz band link) between AP2 and STA2. As disclosed, the BRP training PPDU sequence 53 is sent with the negotiated number of Tx/Rx beams. After the BRP training PPDU sequence 53 is completed and the STA2 transmits a responder feedback message 54 to AP2 through the mmWave link (e.g., a 60 GHz band link).

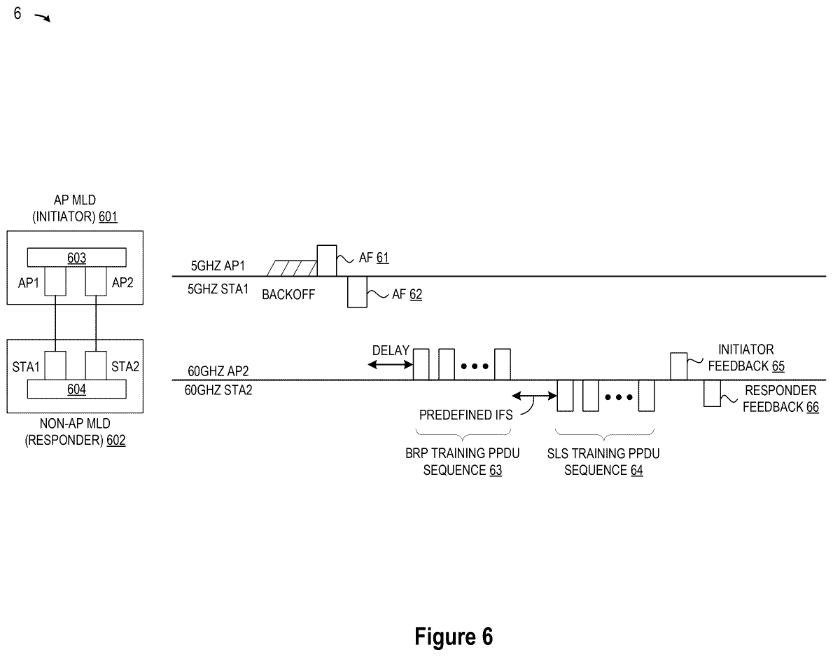

To provide additional details for an improved understanding of selected embodiments of the present disclosure, reference is now made to FIG. 6 which depicts a second case example of a frame exchange sequence for an MLO-assisted BRP procedure 6 for an initiator (AP MLD) 601 and a responder (non-AP MLD) 602 which do not have TX/RX beam reciprocity and which exchange announcement frames (AF) 61, 62 on a non-mmWave link to set up the initiator and responder to sequentially transmit respective BRP training PPDU sequences 63, 64 at the mmWave link, where the initiator and responder separately send feedback message 65, 66 at the mmWave link. In the depicted MLO-assisted BRP procedure 6, frames are exchanged between an AP MLD 601 (which includes a common MAC controller 603 and two wireless APs AP1, AP2) and a non-AP MLD 602 (which includes a common MAC controller 604 and two wireless STAs STA1, STA2). In selected embodiments, the common MAC controller 603 implements upper layer MAC functionalities of the AP MLD 601, and a link specific part of the AP MLD 601 (i.e., AP1, AP2) implements lower layer MAC functionalities of the AP MLD 601. In similar fashion, the common MAC controller 604 implements upper layer MAC functionalities of the non-AP MLD 602, and a link specific part of the non-AP MLD 602 (i.e., STA1, STA2) implements lower layer MAC functionalities of the non-AP MLD 602. As will be appreciated, the AP MLD 601 and non-AP MLD 602 may be implemented with any suitable controller design, such as a host processor and network interface connected to a MAC processor and PHY processor.

In the example frame exchange sequence for an MLO-assisted BRP procedure 6 where the initiator (AP MLD 601) and responder (non-AP MLD 602) do not have the Tx/Rx beam reciprocity, the responder's BRP training PPDU sequence 64 will follow after the initiator's BRP training PPDU sequence 63. In particular, the example frame exchange sequence for the MLO-assisted BRP procedure 6 starts after an initial backoff period expires (i.e., backoff counter becomes zero) when AP1 transmits a first announcement frame 61 to STA1 through the non-mmWave link, and STA1 replies by transmitting a second announcement (response) frame 62 through the non-mmWave link. Through the announcement frame exchange, the information of the best available Tx AWV information for AP2 and STA2 transmission during the BRP procedure is negotiated. Next, the initiator and the responder (e.g., AP2 and STA2, respectively) negotiate a delay time (DELAY) required between the end of the announcement frame exchange and the start of sounding in a mmWave link (e.g., a 60 GHz band link) between AP2 and STA2. As disclosed herein, the delay between AF packet exchange 61, 62 in non-mmWave link and the BRP training PPDU transmission 63 in the mmWave link could be: (1) a predefined IFS if the medium is available, (2) a medium access time with backoff based on the medium availability status according to clear channel assessment (CCA) function. After the delay time, the initiator (AP2) transmits the BRP training PPDU sequence 63 on the mmWave link between AP2 and STA2, and then the responder (STA2) transmits the BRP training PPDU sequence 64 on the mmWave link between STA2 and AP2. In selected embodiments, there is a predefined delay, such as a predefined interframe space (IFS), between the end of the initiator BRP training PPDU sequence 63 and the start of the responder BRP training PPDU sequence 64. In other embodiments (not shown), the initiator BRP procedure and the responder BRP procedure can be independently initiated within their own TXOP. After the responder BRP training PPDU sequence 64 is completed, the initiator (AP2) transmits an initiator feedback message 65 to STA2 through the mmWave link (e.g., a 60 GHz band link), followed by the responder (STA2) transmitting a responder feedback message 66 to AP2 through the mmWave link. Though the sequential transmission of BRP training PPDU sequences 63, 64 and BRP feedback frames 65, 66 can be communicated or conducted through the mmWave link in response to a single announcement frame exchange 61, 62, separate announcement frame exchanges can be used so that a first announcement frame exchange is used to initiate the initiator BRP training PPDU sequence and responder feedback frame, and a second announcement frame exchange is used to initiate the responder BRP training PPDU sequence and initiator feedback frame. Alternatively, the BRP feedback frames 65, 66 can be sent in response to a BF polling packet sent by the responder 602 or the initiator 601 respectively over the non-mmWave or mmWave link.

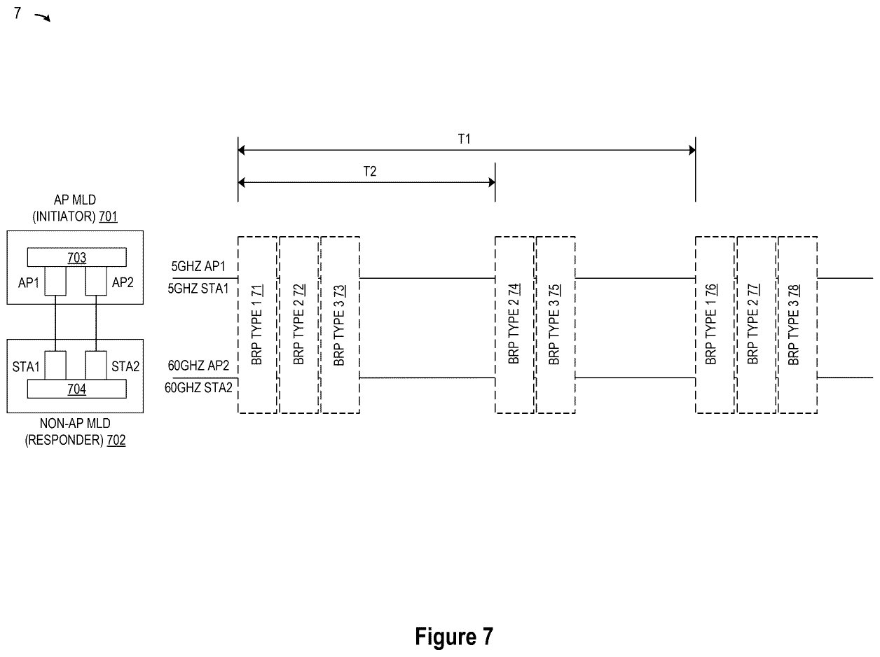

To provide additional details for an improved understanding of selected embodiments of the present disclosure, reference is now made to FIG. 7 which depicts a timing diagram 7 wherein different types of BRP training PPDU sequences are used to perform MLO-assisted beam tracking and refinement. In the depicted timeline 7, frames are exchanged between an AP MLD 701 (which includes a common MAC controller 703 and two wireless APs AP1, AP2) and a non-AP MLD 702 (which includes a common MAC controller 704 and two wireless STAs STA1, STA2). In selected embodiments, the common MAC controller 703 implements upper layer MAC functionalities of the AP MLD 701, and a link specific part of the AP MLD 701 (i.e., AP1, AP2) implements lower layer MAC functionalities of the AP MLD 701. In similar fashion, the common MAC controller 704 implements upper layer MAC functionalities of the non-AP MLD 702, and a link specific part of the non-AP MLD 702 (i.e., STA1, STA2) implements lower layer MAC functionalities of the non-AP MLD 702. As will be appreciated, the AP MLD 701 and non-AP MLD 702 may be implemented with any suitable controller design, such as a host processor and network interface connected to a MAC processor and PHY processor.

As described herein, there can be different types of BRP training based on the different training purposes. In a first BRP training type, joint training for both Tx and Rx AWVs can be done in one or multiple training PPDUs. In a second BRP training type, only Tx beam refinement is performed while the best Rx AWV is fixed and applied at the receiver. And in a third BRP training type, Rx beam refinement is performed while the best Tx AWV is fixed and applied at the transmitter. By selectively deploying the different types of MRB training, the training overhead can be simplified with a hierarchical AWV/beam design instead of training all the Tx/Rx AWVs/beams in one shot. As disclosed herein, the selection of the BRP training type is exchanged in the initial announcement frame exchange.

In the depicted timing diagram 7, a first type of joint training (BRP type 1) 71 can be used with coarser AWV/Beam training for performing beam tracking upon channel changes, followed by a second type of TX beam refinement training (BRP type 2) 72 and a third type of RX beam refinement training (BRP type 3) 73 for finer AWV/Beam training around the best Tx/Rx AWV/Beam found in the previous BRP procedures. As disclosed herein, the proper Tx AWV/Beam mapping between the Types 1 and 2 will need to be considered with feedback information. Of course, if the AWV/Beam design in the first type of joint training (BRP type 1) 71 already includes fine beams, then the second and third types of BRP training can be skipped.

To account for conditions where the channel changes, the first type of joint training (BRP type 1) should be repeated on a first periodic or regular training period basis T1, where the second and third types of BRP training (BRP type 2 and BRP type 3) can have second periodic or regular training period basis T2, e.g., T2≤T1. By scheduling the first type of joint training (BRP type 1) 71, 76 to repeat on a longer periodic or regular training period basis T1, it can provide coarser AWV/beam training for tracking on channel changes. And by scheduling the second and third types of BRP training (BRP type 2 and BRP type 3) to repeat on a shorter periodic or regular training period basis T2, they will occur more frequently to train the finer AWV/Beam around the best Tx/Rx AWV/Beam found in the first type of joint training (BRP type 1) 71. In the depicted example, each of the first, second, and third types of BRP training may have an initiation and BRP training step for transmitting one or more BRP training PPDU sequences in the mmWave link. In addition, the first and second types of BRP training will include a BRP feedback step, but the third type of BRP training does not require a feedback step since its Rx beam training and the information is maintained at Rx only.

If the training PPDU transmitter has multiple transmit RF chains, the training (TRN) fields can be configured to perform BRP training on each transmit chain independently with independent training PPDUs. Alternatively, the training (TRN) fields can be configured to perform BRP training with multiple transmit chains enabled simultaneously. In this case, each transmit chain will be mapped to the single space-time stream by applying spatial expansion with orthogonal waveforms at each TRN field. In addition, the receiver will use the best known directional-Rx for each Rx RF chain except the TRN fields for Rx AWV/beam training. If some Rx RF chain is not trained before, it will be implementation dependent to choose the Rx AWV or use omni-Rx for that RF chain. This option could be more efficient for fine Tx AWV/beam as in the second type of TX beam refinement training (BRP type 2). Otherwise, there will be too many combinations.

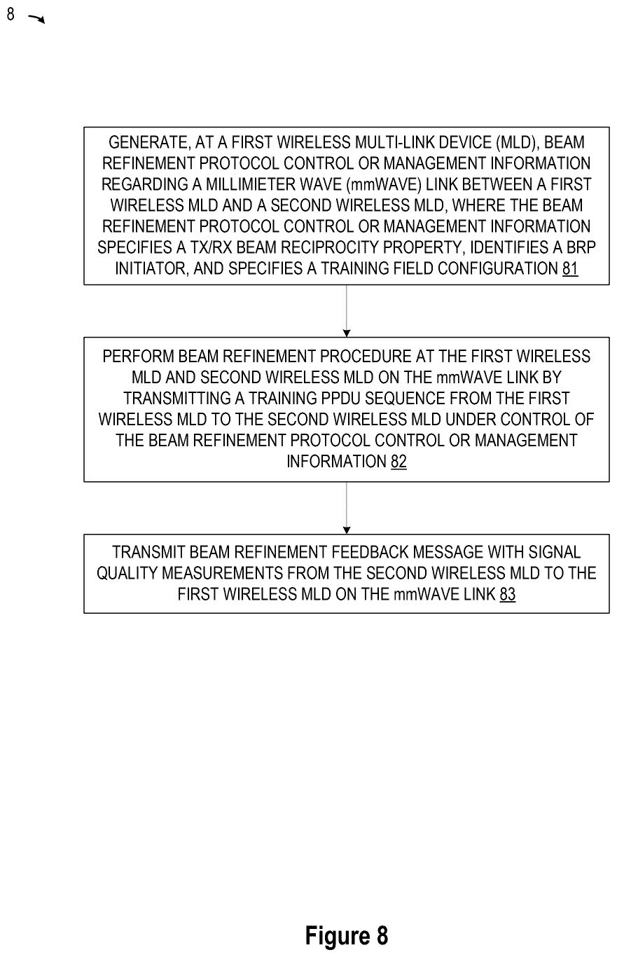

To provide an improved understanding of selected embodiments of the present disclosure, reference is now made to FIG. 8 which illustrates a process flow diagram of a method for wireless communications. At step 81, a first wireless multi-link device (MLD) generates beam refinement protocol control or management information regarding a millimeter wave (mmWave) link between the first wireless MLD and a second wireless MLD, where the beam refinement protocol control or management information specifies a TX/RX beam reciprocity property, identifies a BRP initiator, and specifies a training field configuration. At step 82, the first and second wireless MLDs perform a beam refinement procedure on the mmWave link by transmitting a training PPDU sequence from the first wireless MLD to the second wireless MLD under control of the beam refinement protocol control or management information. At step 83, the second wireless MLD may transmit a beam refinement feedback message with signal quality measurements to the first wireless MLD through the mmWave link.

In selected embodiments, the first wireless MLD includes an access point (AP) MLD that includes a wireless AP, and the second wireless MLD includes a non-AP MLD that includes a non-AP station (STA). In selected embodiments, the non-mmWave link includes one of a 2.4 Gigahertz (GHz) link, a 5 GHz link, or a 6 GHz link, and the mmWave link includes a 45 GHz link or a 60 GHz link. In selected embodiments, the control or management information regarding the mmWave link is transmitted to the second wireless MLD through the non-mmWave link between the first wireless MLD and the second wireless MLD. In selected embodiments, the control or management information regarding the mmWave link includes link connection establishment information regarding the mmWave link. In selected embodiments, the control or management information regarding the mmWave link includes mmWave sounding announcement information regarding the mmWave link that initiates a beam refinement protocol training between the first wireless MLD and the second wireless MLD. In selected embodiments, the control or management information regarding the mmWave link is negotiated by exchanging at least an announcement frame, alone or in combination with a control frame exchange, on the non-mmWave link. In selected embodiments, the first wireless MLD transmits the control or management information regarding the mmWave link to the second wireless MLD through at least the non-mmWave link between the first wireless MLD and the second wireless MLD. In selected embodiments, the first wireless MLD sends beam refinement protocol training PPDUs over the mmWave link to the second wireless MLD under control of the control or management information, and the second wireless MLD transmits a signal quality measurement of the BRP training PPDUs received over the mmWave link. In some embodiments, the first wireless MLD includes a non-AP MLD that includes a non-AP station (STA), the non-AP station includes the controller and the wireless transceiver, and the second wireless MLD includes an AP MLD that includes a wireless AP. In some embodiments, the first wireless MLD is compatible with an Institute of Electrical and Electronics Engineers (IEEE) 802.11 protocol.

In accordance with the present disclosure, there is provided a method of MLO-assisted analog beam training for using a mmWave link and at least another non-mmWave link to perform a beam refinement protocol (BRP) to do beam tracking for the slow channel change or further beam refinement on the mmWave link between first and second wireless devices after the mmWave link is already established with an initial sector level sweep (SLS) phase. In the method, a first wireless device transmits an announcement frame (or a setup frame or control frame) that is received and acknowledged by the second wireless device transmitting another announcement frame in the same link to complete the announcement frame exchange. Using the announcement frame exchange, the first and second wireless devices negotiate all the training parameters needed for the subsequent BRP training, including the number of transmit/receives beams, training (TRN) field configurations, etc. In such embodiments, the best available Tx/Rx AWV/beam pair exchanged may also be used by the BRP training PPDU transmission/packet detection and the BRP feedback frame transmission/reception. And they could use the same PPDU format/BW in the non-TRN fields as in the sector level sweep procedure. In embodiments where the information of the best available Tx/Rx AWV pair to connect the first and second wireless devices is exchanged before the announcement frame exchange by using a control frame exchange in non-mmWave link, the announcement frame exchange could happen at the mmWave link. Otherwise, the announcement frame exchange would happen in the non-mmWave link, and the best available Tx/Rx AWV pair information needs to be included in the announcement frame exchange for later BRP training PPDU transmission/reception. After a specified delay, the first wireless device transmits a BRP training PPDU sequence at the mmWave link, and the second wireless device detects and measures a training PPDU signal quality to determine the transmit AWV/beam ranking of the first wireless device and the corresponding best Rx AWV/beam at the second wireless device. In selected embodiments, the BRP training PPDU sequence may be transmitted SIFS after the announcement frame exchange if the exchange is at the same mmWave link, otherwise, the BRP training PPDU sequence is transmitted with a delay after the announcement frame exchange at the non-mmWave link, where the delay could be either a predefined IFS or a medium access time with random backoff based on medium status. In addition, the second wireless device transmits a BRP feedback frame to the first wireless device at the mmWave link which contains the Tx AWV/beam ranking info of the second wireless device. If the first and second wireless devices have Tx/Rx beam reciprocity in the mmWave link, the BRP training PPDU sequence is transmitted only from the first wireless device to the second wireless device. However, if the first and second wireless devices do not have TX/RX beam reciprocity, the second wireless device may optionally transmit a BRP training PPDU sequence at the mmWave link to train the reverse direction, and the first wireless device may detect and measure a training PPDU signal quality to determine the transmit AWV/beam ranking of the second wireless device and the corresponding best Rx AWV/beam at the first wireless device. In such embodiments, the BRP training PPDU sequence for the reverse direction could be started either sequentially with a predefined IFS after the initiator BRP by the first wireless device, or independently initiated by another announcement frame exchange. The former will have delayed feedback sent out after the BRP training for the reverse direction finishes, while the latter can have immediate feedback right after the BRP training PPDU sequence. The feedback can also be solicited by the transmitter in either mmWave or non-mmWave link if it's not sent right after the BRP training PPDU sequence in the mmWave link. In addition, the first wireless device may optionally transmit a BRP feedback frame to the second wireless device at the mmWave link which contains the Tx AWV/beam ranking info of the second wireless device. In selected embodiments, the training (TRN) fields would be appended at the last portion of each BRP training PPDU and are applied with different transmit and/or receive beams from the non-TRN fields to evaluate the new beam quality. In such embodiments, the training (TRN) fields can be configured and categorized into different types with different training purposes, including a first BRP training type for joint training for both Tx and Rx AWVs, a second BRP training type for Tx beam refinement with the best Rx AWV applied at the receiver, and third BRP training type for Rx beam refinement with the best Tx AWV applied at the transmitter. As disclosed herein, the first BRP training type 1 may be applied with coarser beams for beam tracking/refinement due to the slow channel change or refinement, and the second and third BRP training type will do further Tx/Rx beam refinement around the best coarse beam found in the first BRP training type. However, the second and third BRP training types can be skipped if the first training type contains enough fine beams for the antenna configuration with reasonable complexity. As disclosed herein, the first and second BRP training types may include corresponding feedback frames from the training PPDU receiver, but the third BRP training type does not require feedback as the training is for the Rx beams where the relationship with the corresponding Tx beam is maintained at the training PPDU receiver. In addition, the first BRP training type may have a training period configuration T1 that is different from the training period configuration T2 of the second and third BRP training types based on consideration of overhead vs. performance trade off. In embodiments where multiple transmit RF chains are available, the TRN fields can be configured to perform BRP training on each transmit chain independently (with independent training PPDU). Alternatively, the TRN fields can be configured to perform BRP training with multiple transmit chains enabled simultaneously, with each transmit chain mapped to a single space-time stream by applying spatial expansion with orthogonal waveforms at each TRN field. The decision for choosing between the TRN field configuration choices may be based on the type of consider the BRP training type and the associated complexity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner. It should also be noted that at least some of the operations for the methods described herein may be implemented using software instructions stored on a computer useable storage medium for execution by a computer. As an example, an embodiment of a computer program product includes a computer useable storage medium to store a computer readable program. The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD). Alternatively, embodiments of the invention may be implemented entirely in hardware or in an implementation containing both hardware and software elements. In embodiments which use software, the software may include but is not limited to firmware, resident software, microcode, etc.

By now it should be appreciated that there has been provided a wireless communication apparatus, method, and system for performing analog beamforming training with beam tracking for slow channel changes or beam refinement by a first wireless multi-link device (MLD) in accordance with Institute of Electrical and Electronics Engineers (IEEE) 802.11 protocol and other next-generation wireless protocols. In the disclosed methodology, a first wireless MLD and a second wireless MLD generate beam refinement training control information regarding an established millimeter wave (mmWave) link between the first wireless MLD and a second wireless MLD. In selected embodiments, the beam refinement training control information includes a first indicator of a transmit/receive beam reciprocity value for the first and second wireless MLDs, a second indicator identifying which of the first or second wireless MLD is an initiator, and a third indicator specifying a training parameter which includes a training field configuration. In selected embodiments, the beam refinement training control information is generated by the first wireless MLD which transmits a first control/management frame regarding the mmWave link to the second wireless MLD through the non-mmWave link between the first wireless MLD and the second wireless MLD; and then receives a second control/management response frame sent by the second wireless MLD through the non-mmWave link, where information contained in the first control/management frame and second control/management response frame are used to specify a best available transmit/receive AWV or beam pair for the first wireless MLD and second wireless MLD. In such embodiments, the generation of the beam refinement training control information also includes the first wireless MLD transmitting a first announcement frame regarding the mmWave link to the second wireless MLD through the mmWave link between the first wireless MLD and the second wireless MLD; and then receiving a second announcement response frame sent by the second wireless MLD through the mmWave link, where information contained in the first announcement frame and second announcement response frame are used to specify a plurality of beam refinement training parameters comprising a number of transmit/receive beams and one or more training field configurations for use in generating the first beam refinement training PPDU sequence. In other such embodiments, the generation of the beam refinement training control information may include the first wireless MLD transmitting a first announcement frame regarding the mmWave link to the second wireless MLD through the mmWave link between the first wireless MLD and the second wireless MLD if beam refinement training is only used to train transmit beams at the first wireless MLD with a fixed receive beam at the second wireless MLD. In other selected embodiments, the beam refinement training control information is generated by the first wireless MLD which transmits a first announcement frame regarding the mmWave link to the second wireless MLD through the non-mmWave link between the first wireless MLD and the second wireless MLD; and then receives a second announcement response frame sent by the second wireless MLD through the non-mmWave link, where information contained in the first announcement frame and second announcement response frame are used to specify a plurality of beam refinement training parameters comprising a best available transmit/receive AWV pair for the first wireless MLD and second wireless MLD, a number of transmit/receive beams, and a one or more training field configurations for use in generating the first beam refinement training PPDU sequence. In other selected embodiments, the beam refinement training control information is generated by negotiating a best available transmit/receive AWV pair between the first wireless MLD and second wireless MLD for use in transmitting the first beam refinement training PPDU sequence and receiving the first signal quality feedback message by the first wireless MLD, and for use in receiving the first beam refinement training PPDU sequence and transmitting the first signal quality feedback message by the second wireless MLD. In addition, the disclosed methodology includes the first wireless MLD transmitting a first beam refinement training PPDU sequence to the second wireless MLD through the mmWave link under control of the beam refinement training control information. In selected embodiments, the first wireless MLD transmits the first beam refinement training PPDU sequence after waiting for a specified time delay after an announcement frame exchange between the first wireless MLD and second wireless MLD. In such embodiments, the specified time delay may be predefined Interframe space (IFS) or a medium access time with random backoff based on medium status if the announcement frame exchange is on the non-mmWave link. In other such embodiments, the specified time delay may be a Short Interframe space (SIFS) if the announcement frame exchange is on the mmWave link. The disclosed methodology also includes the first wireless MLD receiving a first signal quality feedback message from the second wireless MLD through the mmWave link or a non-mmWave link in response to the second wireless MLD detecting and measuring a first signal quality measure based on the first beam refinement training PPDU sequence received by the second wireless MLD under control of the beam refinement training control information. In the disclosed methodology, the first wireless MLD uses the first signal quality measure to perform beam tracking and refinement to the established mmWave link by determining the transmit antenna weight vectors (AWV) or beam ranking for analog beamforming of the first wireless MLD. In selected embodiments of the disclosed methodology, the first wireless MLD also receives a second beam refinement training PPDU sequence from the second wireless MLD through the mmWave link under control of the beam refinement training control information where the first indicator signals there is no transmit/receive beam reciprocity between the first and second wireless MLDs; measures a second signal quality measure based on the second beam refinement training PPDU sequence received by the first wireless MLD; and transmits a second signal quality feedback message to the second wireless MLD through the mmWave link or non-mmWave link which includes the second signal quality measure for use by the second wireless MLD to determine transmit antenna weight vectors (AWV) or beam ranking for analog beamforming of the second wireless MLD. In such embodiments, the first wireless MLD may receive the second beam refinement training PPDU sequence from the second wireless MLD through the mmWave link a predefined Interframe space (IFS) after transmitting the first beam refinement training PPDU sequence. In other such embodiments, the first wireless MLD receives the second beam refinement training PPDU sequence from the second wireless MLD through the mmWave link after the first wireless MLD performs an announcement frame exchange with the second wireless MLD. In selected embodiments where each training PPDU in the first beam refinement training PPDU sequence includes one or more non-training fields and one or more training fields, the first wireless MLD may transmit the first beam refinement training PPDU sequence by applying a same or different transmit AWV to each of the one or more training fields. In such embodiments, the one or more training fields may be configured to specify a joint beam tracking/refinement training procedure for both transmit and receive AWVs, a transmit beam refinement training procedure for the first wireless MLD where the second wireless MLD applies a best AWV at a receiver, and a receive beam refinement training procedure for the second wireless MLD where the first wireless MLD applies a best AWV at a transmitter. In selected such embodiments, the joint beam tracking/refinement training procedure may have a first training period configuration, and the transmit beam refinement training procedure and the receive beam refinement training procedure may have a second training period configuration. In selected embodiments, the first training period configuration is the same as the second training period configuration. In other selected embodiments, the first training period configuration is different from or the larger than second training period configuration. In selected embodiments, the one or more training fields may be configured to enable the first wireless MLD to transmit a plurality of first beam refinement training PPDU sequences to independently train a corresponding plurality of transmit RF chains. In other selected embodiments, the one or more training fields may be configured to enable the first wireless MLD to transmit a plurality of first beam refinement training PPDU sequences to simultaneously train a corresponding plurality of transmit RF chains, with each RF transmit chain mapped to a single space-time stream by applying spatial expansion with orthogonal waveforms at each training field.

In another form, there is provided a wireless multi-link device (MLD), system, and associated method of operation. As disclosed, the wireless MLD includes a plurality of wireless transceivers, a memory including operational instructions, and one or more processing modules operably coupled to the plurality of wireless transceivers and the memory, where the one or more processing modules are configured to execute the operational instructions to perform analog beamforming training with beam tracking for slow channel changes or beam refinement. In particular, the one or more processing modules are configured to execute the operational instructions for generating beam refinement training control information regarding an established millimeter wave (mmWave) link between the wireless MLD and a second wireless MLD, where the beam refinement training control information includes a best available transmit/receive AWV pair for the wireless MLD and the second wireless MLD, a number of transmit/receive beams, a training field configuration, transmit/receive beam reciprocity indicator, and information identifying which of the wireless MLD or second wireless MLD is an initiator. In addition, the one or more processing modules are configured to execute the operational instructions for transmitting, by the wireless MLD, a first beam refinement training PPDU sequence to the second wireless MLD through the mmWave link under control of the beam refinement training control information. In addition, the one or more processing modules are configured to execute the operational instructions for receiving, by the wireless MLD, a first signal quality feedback message from the second wireless MLD through the mmWave link or non-mmWave link in response to the second wireless MLD detecting and measuring a first signal quality measure based on the first beam refinement training PPDU sequence received by the second wireless MLD under control of the beam refinement training control information. In this way, the wireless MLD is configured to use the first signal quality measure to perform beam tracking and refinement to the established mmWave link by determining the transmit antenna weight vectors (AWV) or beam ranking for analog beamforming of the wireless MLD. In selected embodiments, the one or more processing modules may also be configured to execute the operational instructions to generate the beam refinement training control information by transmitting, by the wireless MLD, a first setup frame regarding the mmWave link to the second wireless MLD through the non-mmWave link between the wireless MLD and the second wireless MLD; and receiving, by the wireless MLD, a second setup response frame sent by the second wireless MLD through the non-mmWave link, where information contained in the first set frame and second setup response frame are used by the wireless MLD and second wireless MLD to negotiate the beam refinement training control information.

In yet another form, there is provided a wireless access point (AP) of an AP multi-link device (MLD), system, and associated method of operation for perform analog beamforming training to establish a mmWave link in accordance with IEEE 802.11 protocol. As disclosed, the wireless AP includes a MAC controller configured to generate beam refinement training control management information regarding a millimeter wave (mmWave) link between the AP MLD and a non-AP STA MLD, wherein the mmWave link includes a 45 Gigahertz (GHz) link or a 60 GHz link, and wherein the beam refinement training control management information specifies a best available transmit/receive AWV pair for the AP MLD and the non-AP STA MLD, a number of transmit/receive beams, a training field configuration, a transmit/receive beam reciprocity indicator, and information identifying which of the AP MLD or the non-AP STA MLD is an initiator. In addition, the disclosed the wireless AP includes an initiator wireless device that is configured to transmit a first beam refinement training PPDU sequence to a responder wireless device through the mmWave link under control of the beam refinement training control management information, and to receive a first signal quality feedback message from the responder wireless device through the mmWave link or non-mmWave link in response to the responder wireless device detecting and measuring a first signal quality measure based on the first beam refinement training PPDU sequence received by the responder wireless device under control of the beam refinement training control management information. In this way, the initiator wireless device uses the first signal quality measure to determine a plurality of transmit antenna weight vectors (AWV) or beam ranking for analog beamforming of the initiator wireless device.

Although the described exemplary embodiments disclosed herein are directed to a wireless communication station (STA) devices which provide a multi-link operation assisted analog beam training procedure for using a non-mmWave link between first and second wireless devices to perform beam tracking and refinement on a mmWave link that is 802.11-compliant wireless connectivity applications and methods for operating same, the present invention is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements may be used in order to implement MLO-assisted analog beam training procedures. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A wireless communication method for performing analog beamforming training with beam tracking for slow channel changes or beam refinement by a first wireless multi-link device (MLD) in accordance with Institute of Electrical and Electronics Engineers (IEEE) 802.11 protocol, comprising:
generating beam refinement training control information regarding an established millimeter wave (mmWave) link between the first wireless MLD and a second wireless MLD, where the beam refinement training control information comprises a first indicator of a transmit/receive beam reciprocity value for the first and second wireless MLDs, a second indicator identifying which of the first or second wireless MLD is an initiator, and a third indicator specifying a training parameter comprising a training field configuration;
transmitting, by the first wireless MLD, a first beam refinement training PPDU sequence to the second wireless MLD through the mmWave link under control of the beam refinement training control information; and
receiving, by the first wireless MLD, a first signal quality feedback message from the second wireless MLD through the mmWave link or a non-mmWave link in response to the second wireless MLD detecting and measuring a first signal quality measure based on the first beam refinement training PPDU sequence received by the second wireless MLD under control of the beam refinement training control information,
where the first wireless MLD uses the first signal quality measure to perform beam tracking and refinement to the established mmWave link by determining the transmit antenna weight vectors (AWV) or beam ranking for analog beamforming of the first wireless MLD.

2. The wireless communication method of claim 1, further comprising:
receiving, by the first wireless MLD, a second beam refinement training PPDU sequence from the second wireless MLD through the mmWave link under control of the beam refinement training control information where the first indicator signals there is no transmit/receive beam reciprocity between the first and second wireless MLDs;
measuring, by the first wireless MLD, a second signal quality measure based on the second beam refinement training PPDU sequence received by the first wireless MLD; and
transmitting, by the first wireless MLD, a second signal quality feedback message to the second wireless MLD through the mmWave link or non-mmWave link which includes the second signal quality measure for use by the second wireless MLD to determine transmit antenna weight vectors (AWV) or beam ranking for analog beamforming of the second wireless MLD.

3. The wireless communication method of claim 2, where the first wireless MLD receives the second beam refinement training PPDU sequence from the second wireless MLD through the mmWave link a predefined Interframe space (IFS) after transmitting the first beam refinement training PPDU sequence.

4. The wireless communication method of claim 2, where the first wireless MLD receives the second beam refinement training PPDU sequence from the second wireless MLD through the mmWave link after the first wireless MLD performs an announcement frame exchange with the second wireless MLD.

5. The wireless communication method of claim 1, where generating the beam refinement training control information comprises:
transmitting, by the first wireless MLD, a first control/management frame regarding the mmWave link to the second wireless MLD through the non-mmWave link between the first wireless MLD and the second wireless MLD; and
receiving, by the first wireless MLD, a second control/management response frame sent by the second wireless MLD through the non-mmWave link, where information contained in the first control/management frame and second control/management response frame are used to specify a best available transmit/receive AWV or beam pair for the first wireless MLD and second wireless MLD.

6. The wireless communication method of claim 5, where generating the beam refinement training control information comprises:
transmitting, by the first wireless MLD, a first announcement frame regarding the mmWave link to the second wireless MLD through the mmWave link between the first wireless MLD and the second wireless MLD; and
receiving, by the first wireless MLD, a second announcement response frame sent by the second wireless MLD through the mmWave link, where information contained in the first announcement frame and second announcement response frame are used to specify a plurality of beam refinement training parameters comprising a number of transmit/receive beams and one or more training field configurations for use in generating the first beam refinement training PPDU sequence.

7. The wireless communication method of claim 1, where generating the beam refinement training control information comprises:
transmitting, by the first wireless MLD, a first announcement frame regarding the mmWave link to the second wireless MLD through the non-mmWave link between the first wireless MLD and the second wireless MLD; and
receiving, by the first wireless MLD, a second announcement response frame sent by the second wireless MLD through the non-mmWave link, where information contained in the first announcement frame and second announcement response frame are used to specify a plurality of beam refinement training parameters comprising a best available transmit/receive AWV pair for the first wireless MLD and second wireless MLD, a number of transmit/receive beams, and a one or more training field configurations for use in generating the first beam refinement training PPDU sequence.

8. The wireless communication method of claim 1, where generating the beam refinement training control information comprises negotiating a best available transmit/receive AWV pair between the first wireless MLD and second wireless MLD for use in transmitting the first beam refinement training PPDU sequence and receiving the first signal quality feedback message by the first wireless MLD, and in receiving the first beam refinement training PPDU sequence and transmitting the first signal quality feedback message by the second wireless MLD.

9. The wireless communication method of claim 1, where the first wireless MLD transmits the first beam refinement training PPDU sequence after waiting for a specified time delay after an announcement frame exchange between the first wireless MLD and second wireless MLD.

10. The wireless communication method of claim 9, where the specified time delay may be a predefined Interframe space (IFS) or a medium access time with random backoff based on medium status if the announcement frame exchange is on the non-mmWave link.

11. The wireless communication method of claim 9, where the specified time delay may be a Short Interframe space (SIFS) if the announcement frame exchange is on the mmWave link.

12. The wireless communication method of claim 1, wherein each training PPDU in the first beam refinement training PPDU sequence comprises one or more non-training fields and one or more training fields, and where the first wireless MLD transmits the first beam refinement training PPDU sequence by applying a same or different transmit AWV to each of the one or more training fields.

13. The wireless communication method of claim 12, wherein the one or more training fields may be configured to specify a joint beam tracking/refinement training procedure for both transmit and receive AWVs, a transmit beam refinement training procedure for the first wireless MLD where the second wireless MLD applies a best AWV at a receiver, and a receive beam refinement training procedure for the second wireless MLD where the first wireless MLD applies a best AWV at a transmitter.

14. The wireless communication method of claim 13, wherein the joint beam tracking/refinement training procedure has a first training period configuration and where the transmit beam refinement training procedure and the receive beam refinement training procedure have a second training period configuration.

15. The wireless communication method of claim 14, wherein the first training period configuration is different from or the same as the second training period configuration.

16. The wireless communication method of claim 12, wherein the one or more training fields may be configured to enable the first wireless MLD to transmit a plurality of first beam refinement training PPDU sequences to independently train a corresponding plurality of transmit RF chains.

17. The wireless communication method of claim 12, wherein the one or more training fields may be configured to enable the first wireless MLD to transmit a plurality of first beam refinement training PPDU sequences to simultaneously train a corresponding plurality of transmit RF chains, with each RF transmit chain mapped to a single space-time stream by applying spatial expansion with orthogonal waveforms at each training field.

18. The wireless communication method of claim 5, where generating the beam refinement training control information comprises transmitting, by the first wireless MLD, a first announcement frame regarding the mmWave link to the second wireless MLD through the mmWave link between the first wireless MLD and the second wireless MLD if beam refinement training is only used to train transmit beams at the first wireless MLD with a fixed receive beam at the second wireless MLD.

19. A wireless multi-link device (MLD) comprising:
a plurality of wireless transceivers;
memory including operational instructions; and
one or more processing modules operably coupled to the plurality of wireless transceivers and the memory,
wherein the one or more processing modules are configured to execute the operational instructions to perform analog beamforming training with beam tracking for slow channel changes or beam refinement by:
generating beam refinement training control information regarding an established millimeter wave (mmWave) link between the wireless MLD and a second wireless MLD, where the beam refinement training control information comprises a best available transmit/receive AWV pair for the wireless MLD and the second wireless MLD, a number of transmit/receive beams, a training field configuration, transmit/receive beam reciprocity indicator, and information identifying which of the wireless MLD or second wireless MLD is an initiator;
transmitting, by the wireless MLD, a first beam refinement training PPDU sequence to the second wireless MLD through the mmWave link under control of the beam refinement training control information; and
receiving, by the wireless MLD, a first signal quality feedback message from the second wireless MLD through the mmWave link or non-mmWave link in response to the second wireless MLD detecting and measuring a first signal quality measure based on the first beam refinement training PPDU sequence received by the second wireless MLD under control of the beam refinement training control information,
where the wireless MLD uses the first signal quality measure to perform beam tracking and refinement to the established mmWave link by determining the transmit antenna weight vectors (AWV) or beam ranking for analog beamforming of the wireless MLD.

20. The wireless MLD of claim 19, wherein the one or more processing modules are configured to execute the operational instructions to generate the beam refinement training control information by:
transmitting, by the wireless MLD, a first setup frame regarding the mmWave link to the second wireless MLD through the non-mmWave link between the wireless MLD and the second wireless MLD; and
receiving, by the wireless MLD, a second setup response frame sent by the second wireless MLD through the non-mmWave link, where information contained in the first set frame and second setup response frame are used by the wireless MLD and second wireless MLD to negotiate the beam refinement training control information.

21. A wireless access point (AP) of an AP multi-link device (MLD) comprising:
a MAC controller configured to generate beam refinement training control management information regarding a millimeter wave (mmWave) link between the AP MLD and a non-AP STA MLD, wherein the mmWave link comprises a 45 Gigahertz (GHz) link or a 60 GHz link, and wherein the beam refinement training control management information specifies a best available transmit/receive AWV pair for the AP MLD and the non-AP STA MLD, a number of transmit/receive beams, a training field configuration, a transmit/receive beam reciprocity indicator, and information identifying which of the AP MLD or the non-AP STA MLD is an initiator; and
an initiator wireless device that is configured to transmit a first beam refinement training PPDU sequence to a responder wireless device through the mmWave link under control of the beam refinement training control management information, and to receive a first signal quality feedback message from the responder wireless device through the mmWave link or non-mmWave link in response to the responder wireless device detecting and measuring a first signal quality measure based on the first beam refinement training PPDU sequence received by the responder wireless device under control of the beam refinement training control management information,
where the initiator wireless device uses the first signal quality measure to determine a plurality of transmit antenna weight vectors (AWV) or beam ranking for analog beamforming of the initiator wireless device.
